(19) United States
(12) Patent Application Publication
(10) Pub. No.: US 2026/0169187 A1
(43) Pub. Date: Jun. 18, 2026

(54) SYSTEM AND METHOD FOR IMPLICIT NEURAL REPRESENTATION OF GEOLOGIC INTERFACES, GEOLOGIC SURFACES, AND GEOBODIES

(71) Applicant: Chevron U.S.A. Inc., San Ramon, CA (US)

(72) Inventors: Van Hai Nguyen, Austin, TX (US); Bradley Thomas Mallison, Santa Clara, CA (US); Anusha Sekar, Katy, TX (US); Sarah Vitel, Houston, TX (US)

(21) Appl. No.: 19/422,330

(22) Filed: Dec. 16, 2025

Related U.S. Application Data
(60) Provisional application No. 63/735,343, filed on Dec. 18, 2024.

(51) Int. Cl. G01V 20/00

(52) U.S. Cl. CPC G01V 20/00

(57) ABSTRACT

A method is described for geomodeling and, optionally, full waveform inversion, using implicit neural representations (INRs) for geologic surfaces and geobodies. The method receives initial data points corresponding to geologic interfaces, geologic surfaces, geobodies, or any combination thereof; generates at least one implicit neural representation (INR) of the geologic interfaces, geologic surfaces, geobodies, or any combination thereof; and uses the at least one INR to represent the geologic interfaces, geologic surfaces, geobodies, or any combination thereof. The method is executed by a computer system.

### CROSS-REFERENCE TO RELATED APPLICATIONS

This application claims the benefit of U.S. Provisional Application 63/735,343 filed Dec. 18, 2024.

### TECHNICAL FIELD

The disclosed embodiments relate generally to techniques for implicit neural representation of geologic interfaces, geologic surfaces, and geobodies, in particular for use in modeling and full waveform inversion.

### BACKGROUND

Construction of computer models representing geologic structures is a challenging task due to the complexity of the subsurface and the sparsity, resolution limits, and uncertainty of data used for geophysical inversion and integration into geologic models (hereafter geomodels).

Existing solutions for geologic and structural modeling fall into the categories of explicit methods that rely on grids (a.k.a. meshes) made up of nodes (i.e., points), edges, and polygonal interfaces (e.g., triangles or quadrilaterals) that lie on the surfaces and implicit methods that model surfaces as level sets (a.k.a. isosurfaces) of functions defined in 3D space. Implicit methods have gained in popularity due to their flexibility and simplicity of construction compared to explicit methods. Although they are designed to circumvent computational challenges associated with manipulating explicit grids, the most common implicit methods are grid-based in the sense that they compute and store implicit functions at the node positions of a 3D background grid (e.g., an unstructured tetrahedral grid or a structured hexahedral grid). Interpolation on the interfaces and elements of the grid is used to extend the function to any point within the gridded domain. In practice, implicit models are often converted to explicit surfaces and 3D grids that honor the geometry of geologic surfaces.

Implicit functions are constructed by enforcing that their level sets are fit to a set of interpreted data points indicating the location of a surface (in this case, geologic interfaces, geologic surfaces, and geobodies) while also satisfying or minimizing additional linear and/or nonlinear constraints that provide regularization. One regularization constraint, known as a signed distance constraint, enforces that the magnitude of the gradient of the implicit function is approximately unity everywhere. Other common constraints impose a form of smoothness on the implicit surfaces. Smoothness, signed distance, and other constraints are implemented using finite difference or finite element approximations to derivatives of the implicit functions, combined with fitting constraints, and minimized in a least squares sense. Grid-based implicit methods face two main challenges in practice: (1) the development of software is time consuming because sophisticated and specific purpose solvers are required to construct implicit functions and (2) high resolution surfaces are costly to generate in terms of compute time and memory consumption because the background grids contain a very large number of grid nodes that serve as the degrees of freedom for the implicit functions.

The ability to define the location of rock and fluid property changes in the subsurface is crucial to our ability to make the most appropriate choices for purchasing materials, operating safely, and successfully completing projects. Project cost is dependent upon accurate prediction of the position of geologic interfaces or physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for better representation of geologic interfaces and geobodies for seismic modeling and full waveform inversion.

### SUMMARY

In accordance with some embodiments, a method of geomodeling and, optionally, full waveform inversion, using implicit neural representations (INRs) for geologic interfaces is disclosed. The method may include receiving initial data points corresponding to the geologic interfaces, geologic surfaces, geobodies, or any combination thereof, generating at least one implicit neural representation (INR) of the geologic interfaces, geologic surfaces, geobodies, or any combination thereof, using the at least one INR to represent the geologic interfaces, geologic surfaces, geobodies, or any combination thereof, based on the at least one INR, generating a graphic representation of the geologic interfaces, geologic surfaces, geobodies, or any combination thereof, and displaying the graphic representation on a graphical display. In an embodiment, two INRs may be generated, wherein a first INR captures a geometry of a salt boundary, and a second INR captures rock properties outside of the salt boundary. In another embodiment, three INRs may be generated, wherein a first INR captures a geometry of a salt boundary, a second INR captures rock properties of outside of the salt boundary, and a third INR captures a variation of properties within the salt boundary. The geologic interfaces, geologic surfaces, geobodies, or any combination thereof may include one or more faults, one or more geologic horizons, one or more salt bodies, or any combination thereof. In an embodiment, the INR may be used for modeling of faults. In another embodiment, at least two INRs may be used for full waveform inversion. The full waveform inversion may be used to capture salt geometry.

In another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example system for representing geologic surfaces and geobodies for modeling and full waveform inversion; and

FIG. 2 illustrates an example of architecture of an implicit neural representation (INR);

FIG. 3 compares a conventional method using a Cartesian grid with the result of an embodiment of the present invention;

FIG. 4 demonstrates an aspect of an embodiment of an INR;

FIG. 5 illustrates constraints that are used in an embodiment;

FIG. 6 illustrates an example of an embodiment for modeling a fault;

FIG. 7 illustrates an example of an embodiment for modeling geologic horizons;

FIG. 8 illustrates another embodiment using dual INRs; and

FIG. 9 illustrates an example of an embodiment using dual INRs for full waveform inversion of salt bodies.

Like reference numerals refer to corresponding parts throughout the drawings.

### DETAILED DESCRIPTION OF EMBODIMENTS

Described below are methods, systems, and computer readable storage media that provide a manner of representing geologic interfaces/surfaces and geobodies for seismic modeling and full waveform inversion. These embodiments are focused on geometric aspects of geomodeling and specifically on a computational framework and methods for generating and manipulating surfaces that represent geologic interfaces such as faults, geologic horizons, and the boundaries of geologic bodies such as salt. The goal is not only to develop methods for effectively constructing geomodels; these embodiments additionally seek model representations that can integrate with and improve the geophysical inversion processes that traditionally precede geomodeling.

The current invention seeks to circumvent the challenges of conventional methods by avoiding the use of grids entirely and instead utilizing implicit neural representations (INRs) for geologic surfaces. INRs are neural networks such as multilayer perceptrons that parameterize functions by training on discrete samples of the function or derivatives of the function (e.g., samples of its gradient, its Laplacian, or any constraints on those derivatives). In some cases, the terminology ‘neural fields’ to describe functions in 3D space that are represented using the parameters of neural networks. INRs have recently emerged as a popular choice in the scientific machine learning community for shape representation and object reconstruction problems. An embodiment of the present invention uses a particular form of INR, known as a SIREN, that uses a periodic sine activation function. Prior methods have used the application of INRs to stratigraphic geomodeling but did not use SIRENs and did not consider faults, salt bodies, or integration with geophysical inversion processes. There are two related interpretations of the word ‘implicit’ as used in implicit neural representations. In the geomodeling community, ‘implicit’ is used to imply that a 2D surface or object is represented as an isosurface or level set of a 3D function. The 3D function implicitly defines the 2D surface without explicitly describing the surface. In the machine learning community, implicit neural representation of spatial objects or fields implies that the objects are represented by the parameters of a neural network. That is, the parameters of a neural network implicitly describe an object or field. In some instances, our INRs use implicit only in the sense of the machine learning community. For example, an INR can describe the variation of rock properties within a geobody. However, in many instances, we use ‘implicit’ with dual meaning. For example, we use neural networks to implicitly define signed distance functions that implicitly capture the boundaries of salt.

INRs can be considered as a special case of physics-informed neural networks and used to solve general inverse problems involving partial differential equations. Prior methods use the INR to approximate material properties as a continuous function of space and demonstrated easier inversion for the neural network parameters as compared to other more direct parameterizations. Prior methods developed a more efficient implementation on GPUs using the JAX framework. This strategy, that we now refer to as a single INR approach, has shown good potential for scaling to larger 3D FWI problems. However, recent results for 2D synthetic cases show that the method can fail in cases that include complex salt geometry where there is a sharp discontinuity in material properties across the salt boundary. Prior works use level set methods to parameterize salt geometry in FWI, but those approaches do not involve INRs. We are not aware of prior works that use separate INRs to jointly parameterize the rock property variation and the geometry of the salt boundary within the FWI process.

This invention employs implicit neural representations (INRs) for modeling geologic surfaces and integrating those models with full waveform inversion to obtain improved results for cases with salt.

We first consider INRs for the geomodeling use case where we assume that prior interpretations of geologic interfaces are available as input point sets that lie on the surfaces of interest. The task is to train INRs to fit the input data and satisfy regularization constraints such as smoothness and signed distance. We demonstrate that INRs compare favorably to grid-based implicit methods for generating surface models for geologic interfaces such as faults, geologic horizons, and geobodies such as salt. Specifically, we find that for high resolution surface modeling tasks INRs can achieve comparable or better surface quality metrics as grid-based methods with greater efficiency on GPUs and less required memory. In addition, the INR methodology proved to be very flexible and required far less development time than grid-based methods. Our INR framework supports analytical and automatic derivatives and hence avoids the need for finite difference or finite element approximations. Exact and automatic derivatives simplify the implementation of constraints on data fitting, signed distance, and smoothness combined to form the total loss function. The INR framework also naturally accommodates inequalities constraints in the loss function. Moreover, standard minimization techniques on GPUs can efficiently find the neural network parameters that minimize the total loss. Our conclusion is that INRs are a powerful, flexible, and promising approach for a variety of automated geomodeling challenges and a good choice for future geomodeling software development.

We next demonstrate use of an INR for salt geometry within full waveform inversion (FWI), which is more complex than prior works that use a single INR to approximate material properties and those that use a level set representation of salt. Our dual INR formulation for salt geometry and sediment properties is novel and shown to be effective for 2D synthetic problems where the single INR approach gives unsatisfactory results. An important aspect of the dual INR formulation is that the INR for the salt boundary approximately satisfies signed distance. As a result, the potentially complex salt shape is captured by a continuous and well-behaved function that evolves smoothly during FWI iterations and undergoes topological changes (e.g., merging of two salt bodies into one or splitting of one salt body into two) without any special treatment or challenges associated with adapting the numerical parameterization.

More generally, the dual INR formulation demonstrates that multiple INRs can be combined to create complex geomodels that include continuous variation of spatial properties within subdomains and discontinuities in the properties across subdomain boundaries. For example, the dual INR approach can be easily extended to cases where a third INR is used to capture spatial property variation within the salt. We also envision application of multiple INRs to geologic facies modeling and will investigate strategies that use INRs to constrain facies models to honor well bore data. Similarly, we envision using multiple INRs to construct faulted geologic horizon models by combining a continuous base implicit function with local corrections that capture the discontinuities associated with displacements across implicitly represented faults.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

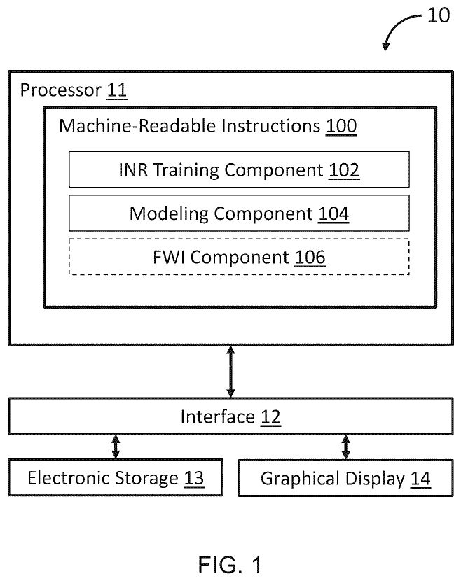

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a graphical display 14, and/or other components.

The electronic storage 13 may be configured to include any electronic storage medium that electronically stores information. The electronic storage 13 may store software algorithms, information determined by the processor 11, information received remotely, and/or other information that enables the system 10 to function properly. For example, the electronic storage 13 may store information relating to input data points such as from log interpretation, and/or other information. For example, the electronic storage 13 may store information relating to output geomodels, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may include one or more non-transitory computer readable storage medium storing one or more programs. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to geomodels, FWI results, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate generating geomodels, with optional use for full waveform inversion. The machine-readable instructions 100 may include one or more computer program components. The machine-readable instructions 100 may include an INR training component 102, a modeling component 104, an optional FWI component 106, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

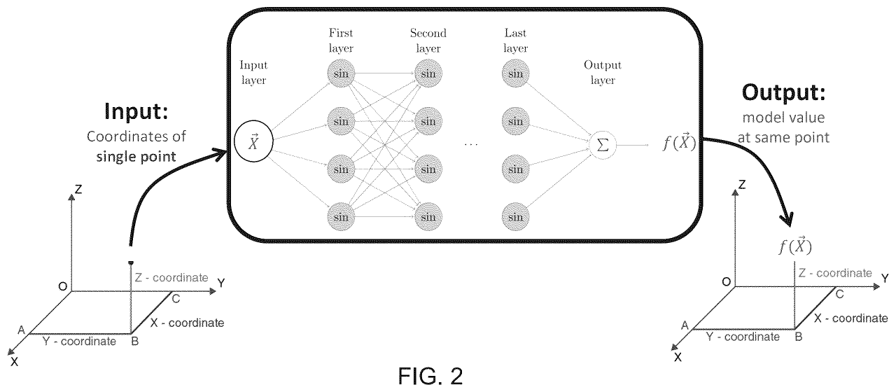

Referring again to machine-readable instructions 100, the INR training component 102 may be configured to train an INR. In a simple form, the INR is a way to parameterize models by neural networks:

$$m ( x ) = {f}_{θ} ( x ) + {m}_{0} ( x )$$

where m(x) is a continuous function representing the model, f_{θ}(x) is a neural network (INR), and m₀(x) is an initial estimate of m(x) and is optional. In an embodiment, f_{θ}(x) may be a SIREN neural network. SIREN is a multilayer perceptron neural network with a sine activation function, which may be written as

$${f}_{θ} ( x ) = {\sum }_{i = 1}^{M} {w}_{i}^{1} sin ( {w}_{i}^{0} x + {b}_{i}^{0} ) + {b}^{1} ,$$

where M is the number of neurons, w⁰ is the frequency, b⁰ is the phase offset, w¹ is the basis coefficients, b¹ is the intercept, and θ={w¹, b¹, w⁰, b⁰} so the degree of freedom for SIREN is the size of θ. Although this is written for two layers, this is not meant to be limiting. The neural network can be designed with any number of layers that make sense for the problem. FIG. 2 illustrates an example architecture of a SIREN neural network. In this embodiment, the INR may receive the coordinates of a single point as input and return a model value for that point as the output. SIREN spans a Fourier-like space, meaning that it is a smooth function space. An advantage to this smooth function space is that finding smooth models, as desired in the present invention, requires less effort and is less likely to get stuck in local minima than when working in a Cartesian grid space.

We now form the inverse (optimization) problem:

$${θ}^{*} = {min}_{θ} {\sum }_{i = 1}^{N} {\vert {m}_{θ} ( {x}^{i} ) - {m}^{i} \vert}^{2} + {λ}_{1} {\sum }_{j = 1}^{n} {\vert \frac{{dm}_{θ}}{dx} {\vert}_{{}_{{}_{{}_{{}_{{x}_{j}}}}}} \vert}^{2} + {λ}_{2} {\sum }_{j = 1}^{n} {\vert \frac{{d}^{2} {m}_{θ}}{{dx}^{2}} {\vert}_{{}_{{}_{{}_{{}_{{x}_{j}}}}}} \vert}^{2}$$

where N is the number of data points, n is the number of evaluation points, and λ₁ and λ₂ are Lagrange multipliers. From this, it is clear that m_{θ}(xⁱ) can be evaluated at exactly all data points and does not require interpolation. Furthermore,

$$\frac{{dm}_{θ}}{dx} {\vert}_{{}_{{}_{{}_{{}_{{x}_{j}}}}}} and \frac{{d}^{2} {m}_{θ}}{{dx}^{2}} {\vert}_{{}_{{}_{{}_{{}_{{x}_{j}}}}}}$$

can be evaluated analytically at arbitrary points, so no grid is required. Auto-differentiation removes the dependence on the grid while providing derivatives at arbitrary points. Furthermore, loss terms are evaluated at points, making it straightforward to add more loss terms at more points. This reduces the coding complexity while also removing the need for a grid.

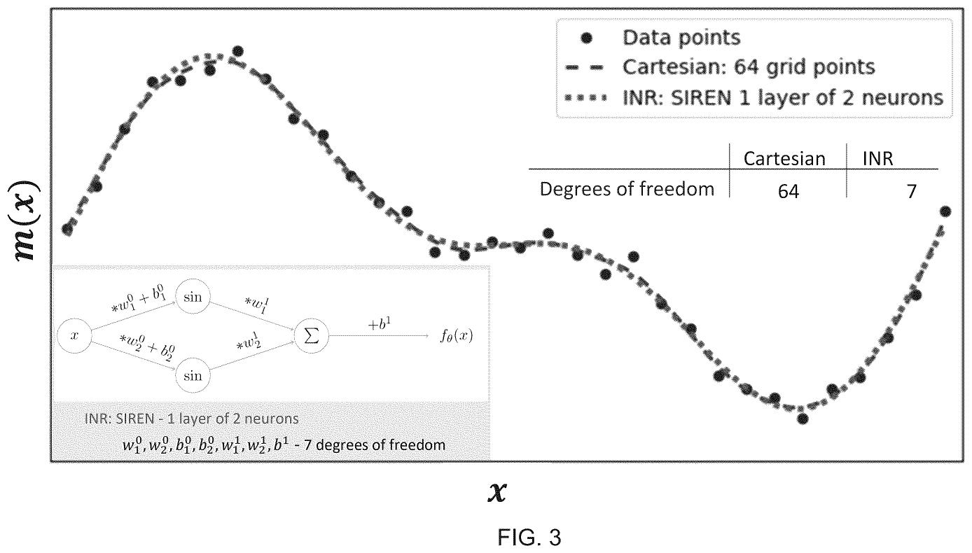

FIG. 3 compares the results of solving for a smooth function using the INR approach of the current invention with the result using a conventional Cartesian grid. In this example, discrete data points are shown as dots. This simple example aims to generate a smooth best-fit line for the data points. The Cartesian grid approach, shown in long dashes, required 64 grid points to achieve approximately the smooth best-fit line achieved by the INR approach of the present invention, shown in short dashes, that used a SIREN with 1 layer of 2 neurons, meaning it only needed 7 degrees of freedom. The conventional Cartesian grid approach needs a fine grid, meaning many degrees of freedom, to account for interpolation from grid points to data points and derivatives approximated by finite differences, resulting in slow computation and expensive memory requirements especially for 3-D models. The novel INR method is more attractive than the conventional Cartesian method in many aspects including being grid-free, having a low degree of freedom while still generating smooth results, lower memory requirements, less sensitivity to initial guess, and lower coding complexity.

The modeling component 104 may be configured to use the trained INR to generate geomodels. Although implicit functions have been used for geomodeling, these are still grid-based and thus are not efficient for high-resolution geologic horizons, faults, and complex geobodies like salt bodies. Therefore, modeling component 104 makes use of the trained INRs. In an embodiment, modeling component 104 may construct Signed Distance (SD) functions from given data points using the INR. Leveraging INRs to create infinite-dimensional SD functions, modeling component 104 has unprecedented flexibility in geological modeling. To be more specific, given SD functions for a dataset, modeling component 104 can merge, intersect, truncate, interact, and edit either with a single fault surface or multiple fault surfaces with ease. Meanwhile, the INR offers the analytical version for any operators taken on the surfaces. By way of example and not limitation, this allows forming unconformity between two geologic horizons at an arbitrary point.

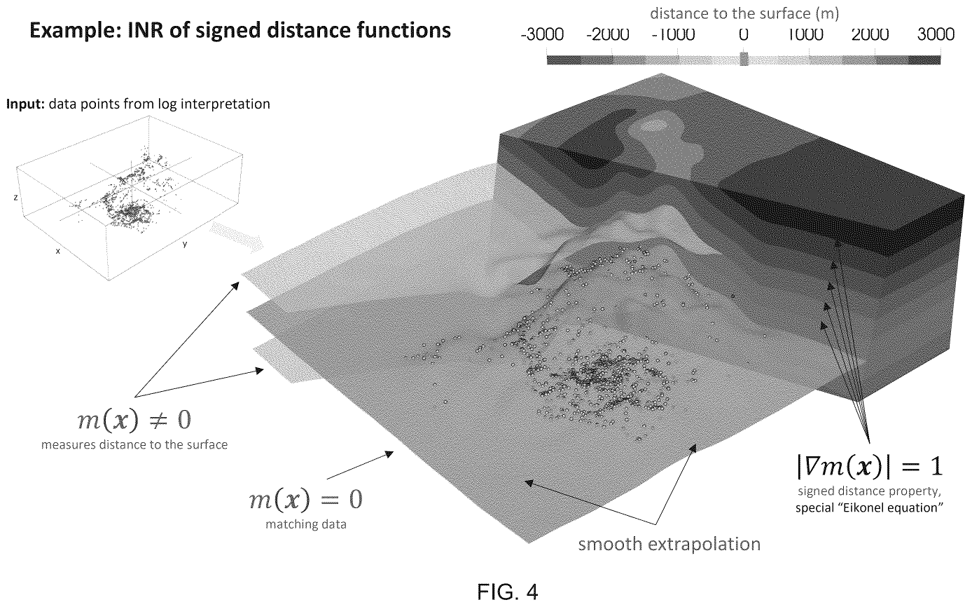

An example of the method used by INR training component 102 and modeling component 104 for signed distance (SD) functions is as follows, and as shown in FIG. 4. To construct a SD function represented by an INR such as a SIREN neural network for parameter set θ, m_{θ}(x), from a set of data points

$$𝒟 = {\{ {x}^{i} \}}_{i = 1}^{N} ,$$

the SD function has two key requirements:
The zero level set fits the data points

$$𝒟 = {\{ {x}^{i} \}}_{i = 1}^{N}$$

The SD properties are satisfied across all points of the domain ∥∇ₓm_{θ}(x^{j})∥=1, x^{j}∈Ω.
   To well-define and control the SD function, the positive and negative sides of the SD function need to be determined by the physics of the problem, and the smoothness of the function is limited to avoid strong oscillations and overfitting of the data points. Therefore, the method uses four constraints for loss functions [symbol] :
1. Fitting data points:

$${ℒ}_{fit} = {\sum }_{i = 1}^{N} {\vert {m}_{θ} ( {x}^{i} ) \vert}^{2}$$

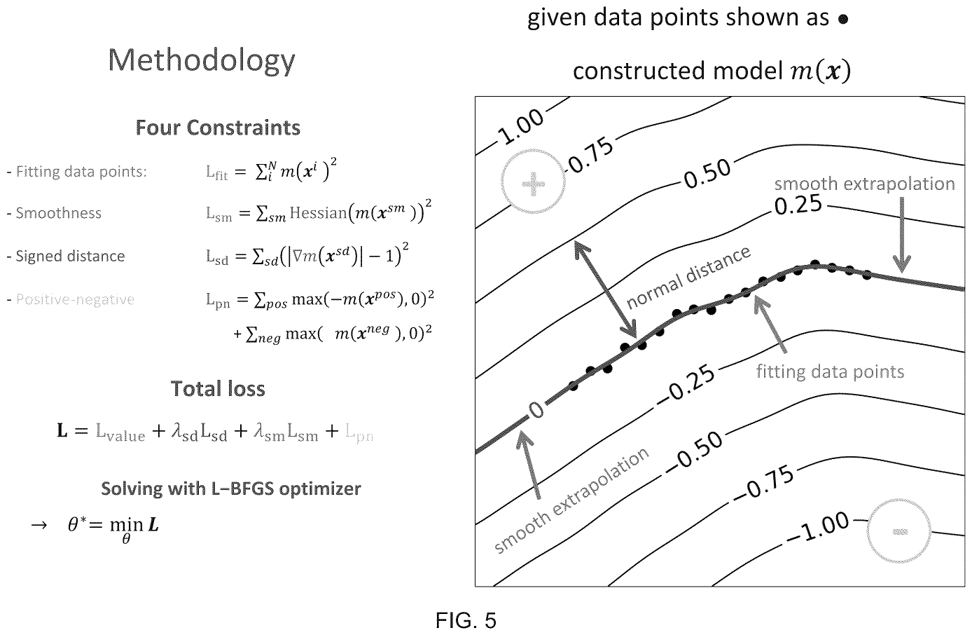

2. SD property: [symbol] =Σ_{SD}∥∇ₓm_{θ}(x^{SD})|−1|²
3. Smoothness:

$${ℒ}_{s m o o t h} = {\sum }_{smooth} {‖ Hessian ( {m}_{θ} ( {x}^{smooth} ) ) ‖}_{F}^{2} ,$$

where ∥ |_{F} is the Frobenius norm
4. Positive and negative side: [symbol] =Σₚₒₛ max(−m_{θ}(x^{pos}),0)²+Σ_{neg} max(+m_{θ}(x^{neg}),0)²
   So the total loss function is:

$$ℒ = {ℒ}_{fit} + {λ}_{S D} {ℒ}_{S D} + {λ}_{smooth} {ℒ}_{smooth} + {ℒ}_{P S}$$

Where λ_{SD}, λₛₘₒₒₜₕ are hyper-parameters to control the contributions of each loss term, and as demonstrated in FIG. 5.

In an embodiment, training the INR may be done by the following steps:
1. Normalize coordinate inputs: to avoid tuning or changing training parameters such as the number of layers, neurons, learning rate, frequency factor of SIREN, etc., for different datasets, we normalize the input coordinates to [−1, 1] and maintain the x, y, z ratio to prevent anisotropy effects on the final SD function. This is particularly important when the depth is much smaller than the horizontal dimensions. Once trained, the function is constructed on the normalized coordinate system and then rescaled back to the physical system in the exact reverse manner. For clarity, all coordinates and datasets mentioned in the following sections are normalized inputs.
2. Specify an initial estimate and INR model for the SD function: rather than starting from a large/complex network, the method can separate the problem into two parts: the known initial properties which are pre-trained and the extra improvement/perturbation, so the network only needs to represent the extra improvement/perturbation, to shorten the training time and thus achieve faster convergence, we introduce a simple and effective initial estimate, m₀(x), for the SD function model, m_{θ}(x). In an embodiment, this may be done by first, performing principal component analysis (PCA) or singular value decomposition on centered data points to achieve the principal directions. The last principal direction (which has the lowest eigenvalue) is used to form the initial estimate. The initial estimate is defined as

$${m}_{0} ( x ) = \tilde{y} if 2 D problem , x , y , coordinates \\ {m}_{0} ( x ) = \tilde{z} if 3 D problem , x , y , z coordinates$$

where \tilde{y} is the last principal direction of the data points in 2D and 2 is the last principal direction of the data points in 3D. These principal coordinates, z, are simply mapped from x with eigenvectors, W, as \tilde{x}=Wx. For a 3D problem, the model for the SD function is defined as m_{θ}(x)=f_{θ}(x)+\tilde{z}.
3. Pick constraint points: constraint points are critical for both the final quality of the SD function and the computational efficiency of the INR approach. These constraint points are based on the factors going into the loss function (fitting, SD, smoothness, and positive/negative side). For example, fitting data points and the smoothness of the SD function conflict may each other. Too large of weighting on any one constraint more than others would lead to poor reconstructed implicit models. On the other hand, if we select too many smoothness constraint points, the training speed will be significantly slower since the smoothness loss requires a double differentiation operator, which is much more expensive than the other terms. Those of skill in the art will appreciate that there are many ways to choose appropriate constraint points, while considering the effects defined in the following table:

Effects on reconstructed function

| Constraints | Fitting | SD | Smoothness | +/− |
|---|---|---|---|---|
| Fitting | Fitting data | Give zero- | Against | |
| | points | level to | smoothness | |
| | | construct | | |
| | | other level | | |
| | | sets | | |
| SD | | Normal | Replicate | |
| | | distance | smoothness | |
| | | | levels | |
| Smoothness | Flatten surface | Smooth | Smoothness | |
| | against fitting | levels | | |
| +/− | | +/−distance | | Well- |
| | | | | defined |

4. Train the model with default training/phase-1 training. Here the training is done using the loss function
   [symbol] +Δ_{SD} [symbol] +λₛₘₒₒₜₕ [symbol] + [symbol] . The training usually converges very early, but further training can yield better fitting data points. In some embodiments, 500 to 5000 epochs provide good results for the default training.
5. Enhance the model with phase-2 training. This may include enforcing smoothness at some points or enforcing fitting of some data points.

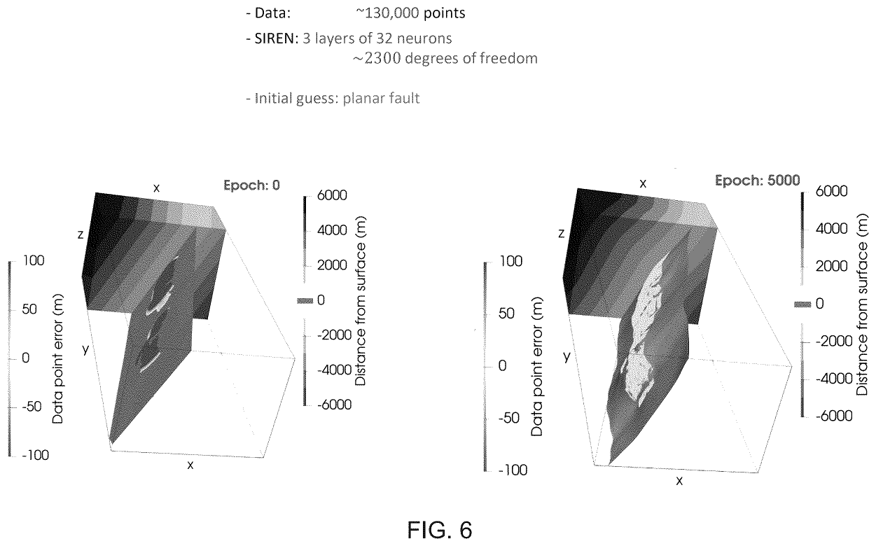

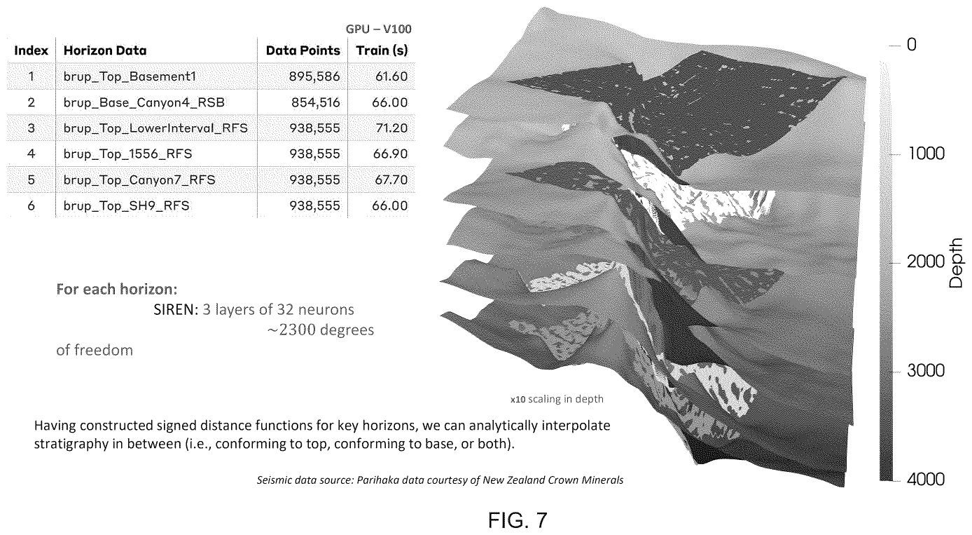

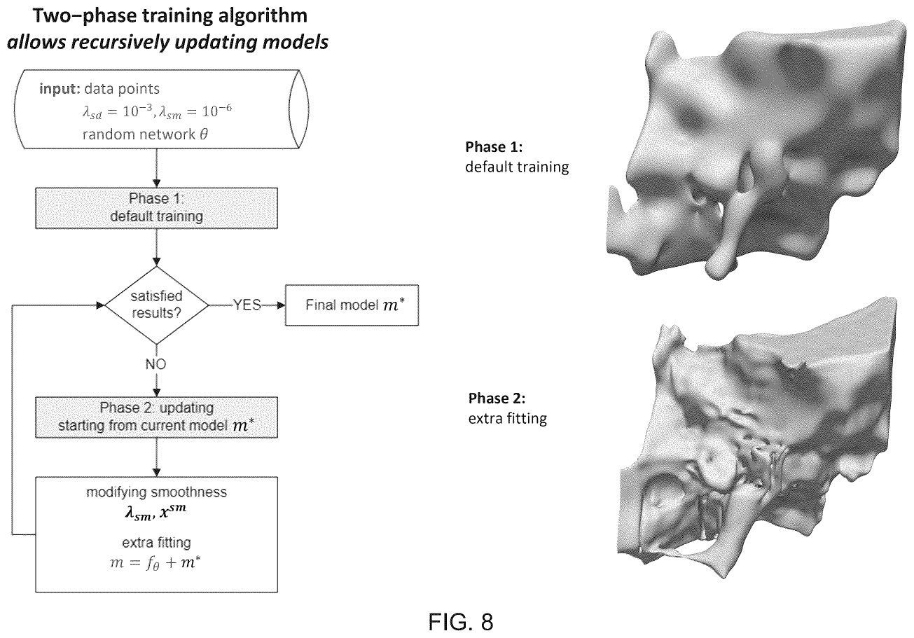

Examples of results of the modeling component 104 can be seen in FIG. 6 (a fault) and FIG. 7 (geologic horizons). FIG. 8 demonstrates a salt body modeled with the phase-1 training (top) and the phase-2 training (bottom), along with the flow chart for the two-phase training.

The optional FWI component 106 may be configured to perform full waveform inversion (FWI) using the INRs. In an embodiment for generating models that include salt bodies, which is one of the most difficult and desired targets of FWI, the method may use dual INRs because we can partition the model as:

$${m}_{( {θ}_{1} , {θ}_{2} )} ( x ) = ( 1 - {a}_{{θ}_{2}} ( x ) ) {m}_{{θ}_{1}}^{s e d} ( x ) + {a}_{{θ}_{2}} ( x ) {m}^{salt} ,$$

where m^{salt} is the known, constant salt velocity,

$${m}_{{θ}_{2}}^{s e d} ( x )$$

represents the spatially varying sediment model, and a_{θ1}(x) is the indicator function that delineates salt from sediment. By way of example and not limitation, a method to train dual INRs for the purpose of full waveform inversion in area containing salt bodies may include:
1. Receive the input data and required components: for FWI, the input data are shot gather data sets d. A partial differential equation (PDE) solver, F, is needed to map the current predicted model mₒ to synthetic modeled shot gathers d. The coordinates are also normalized so that we do not need to tune machine-learning neural network parameters for different problems.
2. Build neural networks for sediment regions: in an embodiment, we use a SIREN neural network to map the coordinates of a point to the velocity models at the same point. The INR for the sediment region is given by

$${m}_{{θ}_{1}}^{s e d} ( x ) = {f}_{{θ}_{1}}^{s e d} ( x ) + {m}_{0}^{s e d} ( x )$$

where

$${m}_{0}^{s e d} ( x )$$

is an initial estimate which can be any reasonable values for velocity models or goo initial models, and

$${f}_{{θ}_{1}}^{s e d} ( x )$$

is the SIREN neural network.
3. Train FWI with given d, F, and

$${m}_{{θ}_{1}}^{s e d}$$

using the optimization problem

$${θ}_{1}^{*} = {min}_{{θ}_{1}} {‖ F ( {m}_{{θ}_{1}}^{s e d} ( x ) ) - d ‖}_{2}^{2} .$$

4. Build an initial estimated shape for salt as a signed distance (SD) function. This can be denoted as

$${m}_{0}^{SD} ( x ) .$$

5. Build the SD function architecture and salt indicator a_{θ}_{₂}(x). Given the pretrained

$${m}_{0}^{S D} ( x ) ,$$

we use another SIREN neural network,

$${m}_{{θ}_{2}}^{S D} ( x ) ,$$

to learn the perturbation from the initial estimate. The final model will be

$${m}_{{θ}_{2}} ( x ) = {f}_{{θ}_{2}}^{S D} ( x ) + {m}_{0}^{S D} ( x ) .$$

6. Build the full salt-sediment velocity models. This evaluates

$${m}_{( {θ}_{1} , {θ}_{2} )} ( x ) = ( 1 - {a}_{{θ}_{2}} ( x ) ) {m}_{{θ}_{1}}^{s e d} ( x ) + {a}_{{θ}_{2}} ( x ) {m}^{salt} .$$

7. Evaluate the total mixed loss and train the sediment INR and the salt indicator INR simultaneously. The total loss for this FWI problem may be written as λ_{SD} [symbol] +λₛₘₒₒₜₕ [symbol] + [symbol] . Then both INRs are trained simultaneously as

$${θ}_{1}^{*} , {θ}_{2}^{*} = {min}_{{θ}_{1} , {θ}_{2}} {‖ F ( {m}_{{θ}_{1}}^{s e d} ( x ) ) - d ‖}_{2}^{2} + {λ}_{2} [ {λ}_{S D} {ℒ}_{S D} + {λ}_{smooth} {ℒ}_{smooth} + {ℒ}_{P S} ]$$

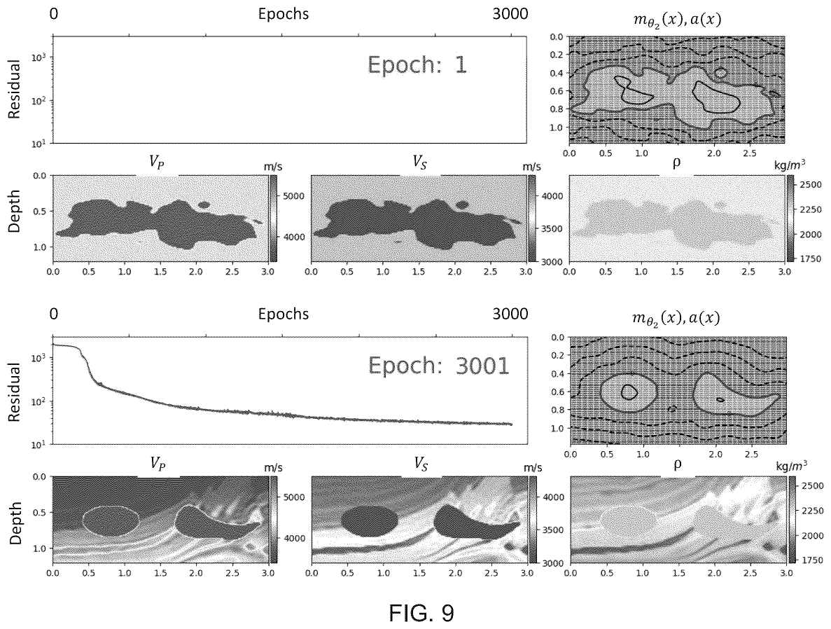

This needs to balance how much each loss term contributes to total loss via the control parameter A₂. We prioritize the salt m_{θ}_{₂}(x) to get the salt shape first and then sediment later. For this problem, there is not a data fitting loss term since we do not have information on exactly where the salt should be. FIG. 9 demonstrates an example using this method, with the epoch 1 (initial models) on the top and the predicted results after 3000 epochs on the bottom.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The present invention relates to a system that incorporates novel machine learning architectures for generating geomodels. These architectures, which surpass human mental processes, operate beyond predefined algorithms and adapt dynamically to input data. In particular, the system leverages INRs and other advanced techniques to achieve unprecedented performance.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of representing geologic interfaces, geologic surfaces, geobodies, or any combination thereof, comprising:
a. receiving initial data points corresponding to the geologic interfaces, geologic surfaces, geobodies, or any combination thereof;
b. generating at least one implicit neural representation (INR) of the geologic interfaces, geologic surfaces, geobodies, or any combination thereof;
c. using the at least one INR to represent the geologic interfaces, geologic surfaces, geobodies, or any combination thereof;
d. based on the at least one INR, generating a graphic representation of the geologic interfaces, geologic surfaces, geobodies, or any combination thereof, and
e. displaying the graphic representation on a graphical display.

2. The method of claim 1 wherein two INRs are generated, wherein a first INR captures a geometry of a salt boundary, and a second INR captures rock properties outside of the salt boundary.

3. The method of claim 1 wherein three INRs are generated, wherein a first INR captures a geometry of a salt boundary, a second INR captures rock properties of outside of the salt boundary, and a third INR captures a variation of properties within the salt boundary.

4. The method of claim 1 wherein the geologic interfaces, geologic surfaces, geobodies, or any combination thereof comprise one or more faults, one or more geologic horizons, one or more salt bodies, or any combination thereof.

5. The method of claim 1 wherein the at least one INR is used for modeling of faults.

6. The method of claim 1 wherein at least two INRs are used for full waveform inversion.

7. The method of claim 6 wherein the full waveform inversion captures salt geometry.

8. A computer system, comprising:
one or more processors;
memory; and
one or more programs, wherein the one or more programs are stored in the memory and configured to be executed by the one or more processors, the one or more programs including instructions that when executed by the one or more processors cause the computer system to:
a. receive initial data points corresponding to geologic interfaces, geologic surfaces, geobodies, or any combination thereof;
b. generate at least one implicit neural representation (INR) of the geologic interfaces, geologic surfaces, geobodies, or any combination thereof;
c. use the at least one INR to represent the geologic interfaces, geologic surfaces, geobodies, or any combination thereof,
d. based on the at least one INR, generate a graphic representation of the geologic interfaces, geologic surfaces, geobodies, or any combination thereof; and
e. display the graphic representation on a graphical display.

9. The computer system of claim 8 wherein two INRs are generated, wherein a first INR captures a geometry of a salt boundary, and a second INR captures rock properties outside of the salt boundary.

10. The computer system of claim 8 wherein three INRs are generated, wherein a first INR captures a geometry of a salt boundary, a second INR captures rock properties of outside of the salt boundary, and a third INR captures a variation of properties within the salt boundary.

11. The computer system of claim 8 wherein the geologic interfaces, geologic surfaces, geobodies, or any combination thereof comprise one or more faults, one or more geologic horizons, one or more salt bodies, or any combination thereof.

12. The computer system of claim 8 wherein the at least one INR is used for modeling of faults.

13. The computer system of claim 8 wherein at least two INRs are used for full waveform inversion.

14. The computer system of claim 13 wherein the full waveform inversion captures salt geometry.
